(19) United States
(12) Patent Application Publication
(10) Pub. No.: US 2015/0228011 A1
(43) Pub. Date: Aug. 13, 2015

(54) METHOD AND SYSTEM FOR MATCHING IT PROVIDERS WITH END CUSTOMERS THROUGH AN ONLINE BIDDING PROCESS

(71) Applicant: PAX8, Inc., Lone Tree, CO (US)

(72) Inventor: Klaus J. Dimmler, Colorado Springs, CO (US)

(73) Assignee: PAX8, Inc., Lone Tree, CO (US)

(21) Appl. No.: 14/179,425

(22) Filed: Feb. 12, 2014

(51) Int. Cl. G06Q 30/08

(52) U.S. Cl. CPC G06Q 30/08

(57) ABSTRACT

A system and method for a distributor of information technology (IT) products and services that has acquired business customers through direct sales matches these customers with IT service providers through an online bidding process. The system and method includes a customer system that is connected to the Internet and is configured to store information about subscriptions and account information about customers and IT providers, and process this information in order to appropriately solicit, analyze, and select bids.

### FIELD OF INVENTION

According to an embodiment of the present invention, a system and method are generally directed to acquisition of business customers in cloud computing environments comprising sales and distribution channels involving multiple buyers and sellers. In particular, the invention presents a system and method for a distributor of subscription-based cloud services to “auction” business customers to IT providers.

### BACKGROUND

Information Technology (IT) products and services are often sold through a distribution channel consisting of vendors, distributors, managed service providers, value added resellers, IT consultants, and end customers. The role of a distributor or value-added distributor is generally to aggregate multiple products from multiple vendors and serve as a single source for managed service providers, IT consultants, and resellers (collectively, “resellers”) to purchase these products and services on behalf of their customers. Resellers, in turn, sell these products and services to their end customers, often along with IT support.

Particularly with the shift to cloud computing, IT products and services are increasingly available “as a service,” usually meaning as an annual or monthly subscription. Under this model, distributor and reseller revenues are expressed as “recurring revenue,” often “monthly recurring revenue.” Thus, an end customer's subscription to a service results in monthly recurring revenue to a reseller and/or distributor.

In an IT channel-based sales model, it may be desirable for an entity, especially a distributor, to conduct sales campaigns directly targeting end customers, thereby establishing a stream of recurring revenue. An ideal IT channel-based business model, however, also involves a reseller to act as the end customer's consultant and source of IT support. Indeed, because the distributor is not in the business of consulting and end customer support, the distributor's business depends on the reseller-customer relationship. Consequently, the distributor's pricing structure generally builds in profit margins for both the distributor and a reseller. Finally, resellers clearly benefit from the acquisition of new customers, especially where those new customers come with an existing stream of recurring revenue.

The prior art includes various auction and bidding inventions. Many of these are systems and methods for purchasing consumer goods online. These include methods of bidding by a customer for a product or service offered by multiple vendors (WO Publication 2001/054023 A1—Bidding Process—Popdynamics, Inc), methods for conducting on-site and online auctions (U.S. Pat. No. 8,527,392 B2—Method and Apparatus for Holding a Two-Stage Live Auction for On-Site and On-Line Bidders—Levy et al.; WO Publication 2001/04723—Method, System and Business Model for a Buyer's Auction with Near Perfect Information Using the Internet—Porat, et al.), as well as A Method of Merchant Bidding for the Sale of Items to Customers (U.S. Pat. No. 315,919 B1—Perrochon et al.—Distributed Electronic Commerce System with Merchant Bidding for Sales of Items). The prior art also includes various methods of matching buyers and sellers (US Application Publication 2012/0310763 A1—Meehan—System and Methods for Matching Potential Buyers and Sellers of Complex Offers).

The prior art includes various methods of auctioning and acquiring customer leads and lists, including a method of supplying customer leads to dealers (U.S. Pat. No. 7,305,364—Nabe et al.—Methods and Systems for Supplying Customer Leads to Dealers), a method of generating customer lists and auctioning them to product dealers (U.S. Pat. No. 7,216,102—Nabe—Methods and Systems for auctioning of pre-selected customer lists), and a method of acquiring customers through offers to pay a portion of a customer's existing bill from another merchant, or through targeted offers to prospective customers (U.S. Pat. No. 8,489,450B2—Agarwal—Systems and Methods for facilitating customer acquisition by businesses).

A unique situation exists, however, with respect to IT distributors that use direct sales methods to close initial sales but ultimately rely on resellers to support and sell to end customers. Therefore, it would be desirable to establish a system and method that allows a distributor to easily match an end customer with an appropriate reseller, thereby ensuring that the customer has a source of consulting and support, while enabling the reseller to acquire new customers and the associated streams of recurring revenue. A bidding format enables the distributor to maximize its benefit from this process. This invention comprises an online bidding system that matches end customers with resellers.

### SUMMARY

According to an embodiment of the present invention, the present system and method describe a means for a distributor of information technology (IT) products and services that has acquired business customers through direct sales to match these customers with IT service providers through an online bidding process. The invention includes a computer system that is connected to the Internet and is configured to store subscription information, and account information about customers and IT providers, and process this information in order to solicit, analyze, and select bids.

In one embodiment, bidding for a customer is triggered by the distributor closing a direct sale of a product or service for which the pricing model is a recurring charge. The system processes the customer information to generate a score for the customer and match the customer with appropriate resellers, then opens bidding to those resellers. Bidding may take the form of an ongoing, online auction, or may be held on a periodic basis, such as monthly, or when a specific number of new customers are available for acquisition. In another embodiment, the bidding is triggered by a customer's request for a quote for a particular product or service. The system determines which resellers are qualified, then seeks bids from those resellers.

Once a reseller's bid is selected, the system associates the customer account with the reseller and establishes the appropriate reseller-distributor transaction. This transaction depends on the system configurations and the reseller's bid. The system may generate a one-time invoice to the reseller, or the bid may be incorporated into the recurring transaction between the reseller and distributor.

### BRIEF DESCRIPTION OF THE DIAGRAMS

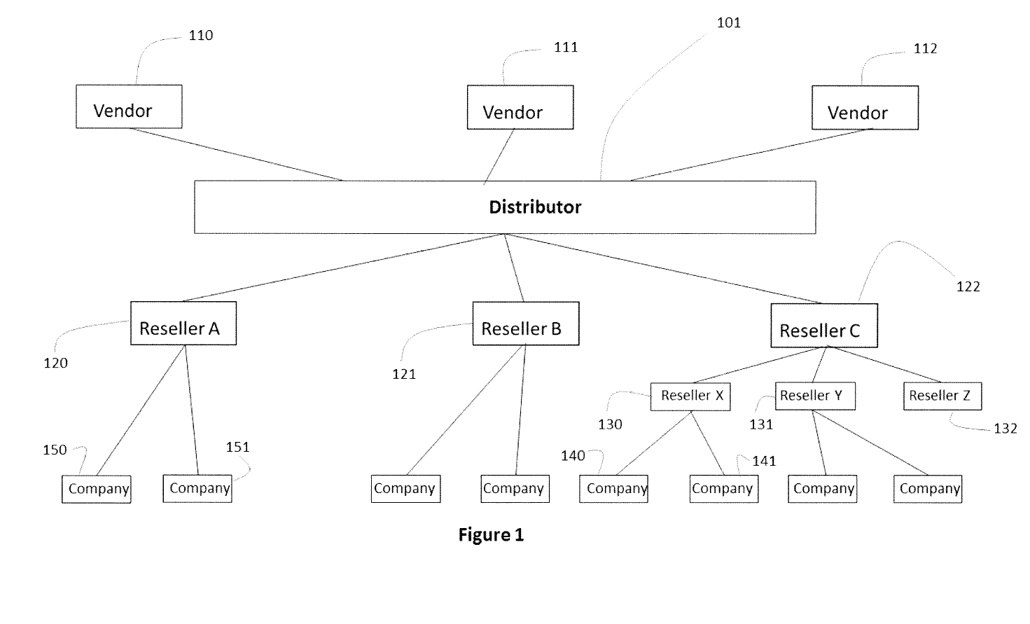

FIG. 1 depicts a typical IT supply chain comprising a distributor that aggregates products and services from multiple vendors and supplies them to IT resellers, which, in turn, supply them to end customers (companies).

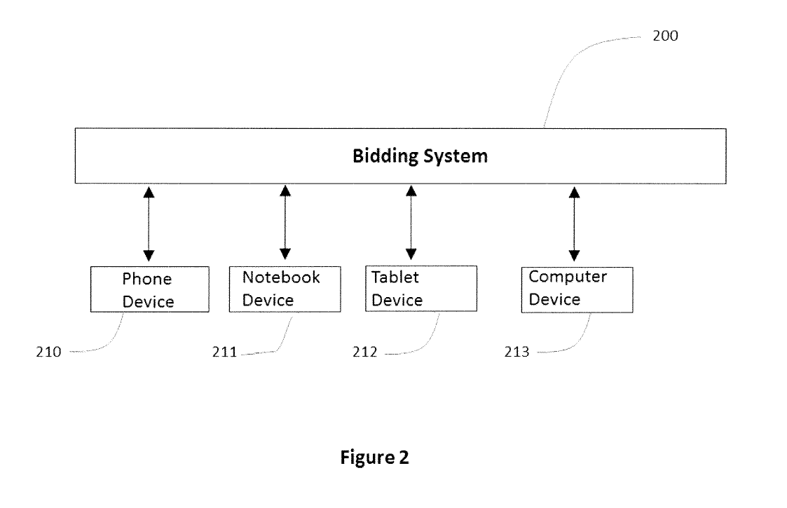

FIG. 2 depicts the connections between multiple computing devices and the bidding system.

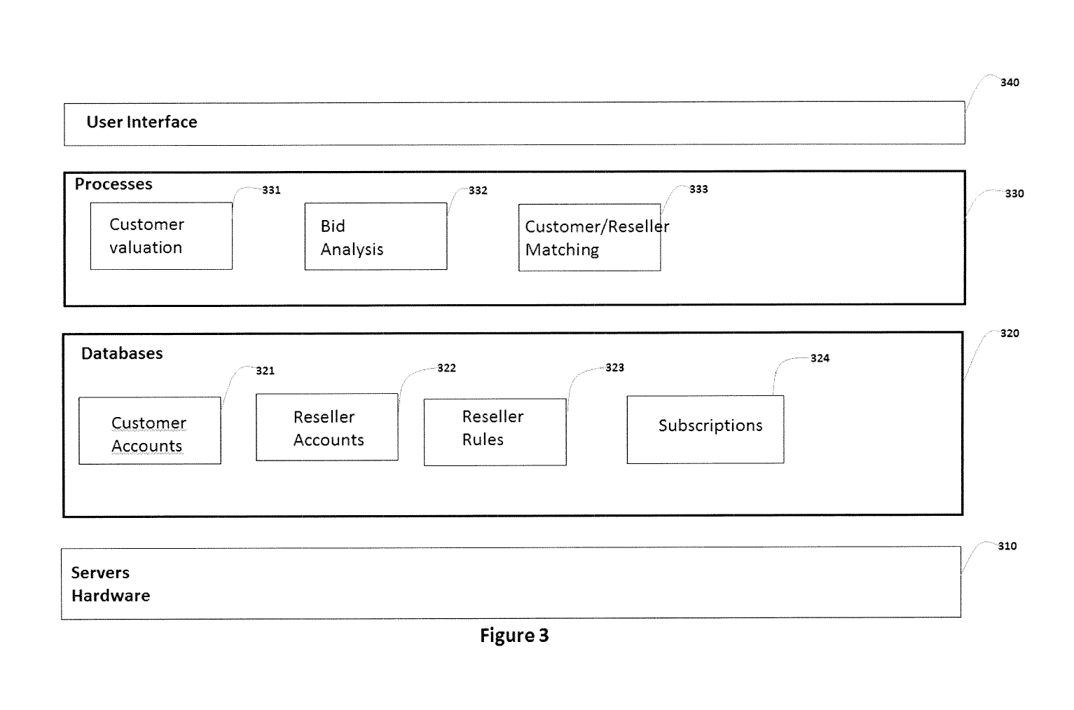

FIG. 3 depicts the basic components of the computer bidding system.

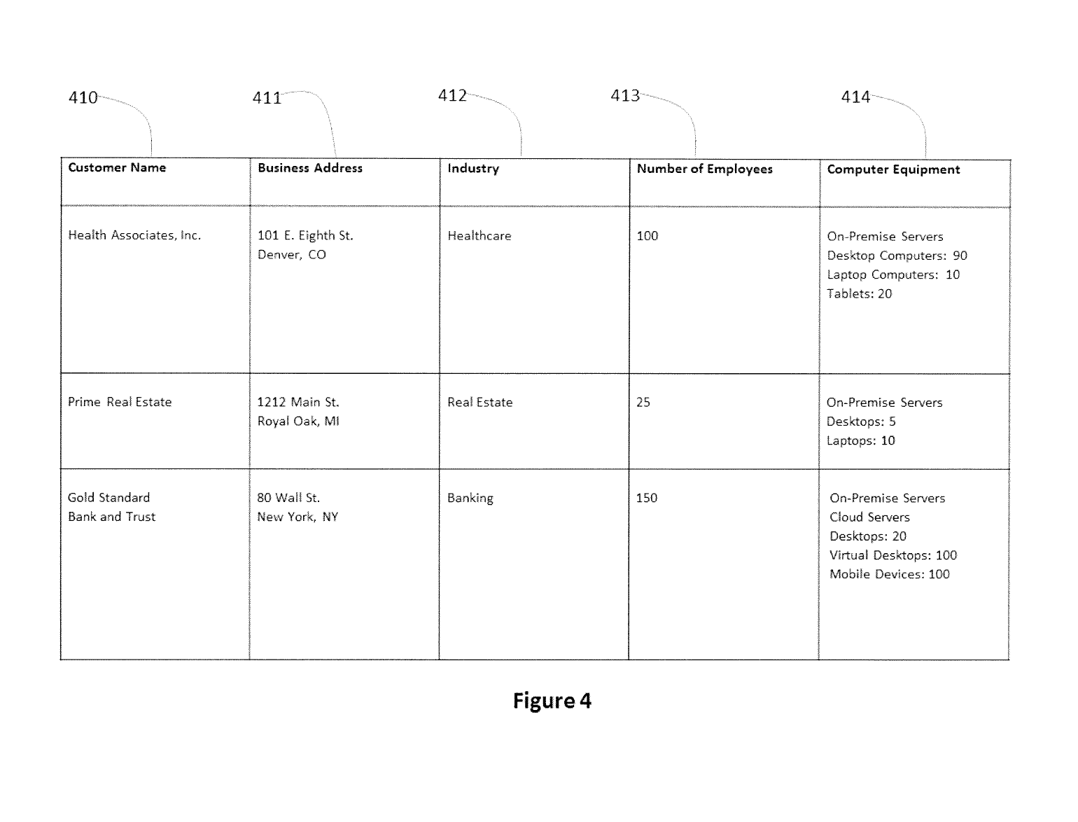

FIG. 4 depicts the customer account database, which stores customer profile information such as customer name, business address, industry, company size, and subscriptions.

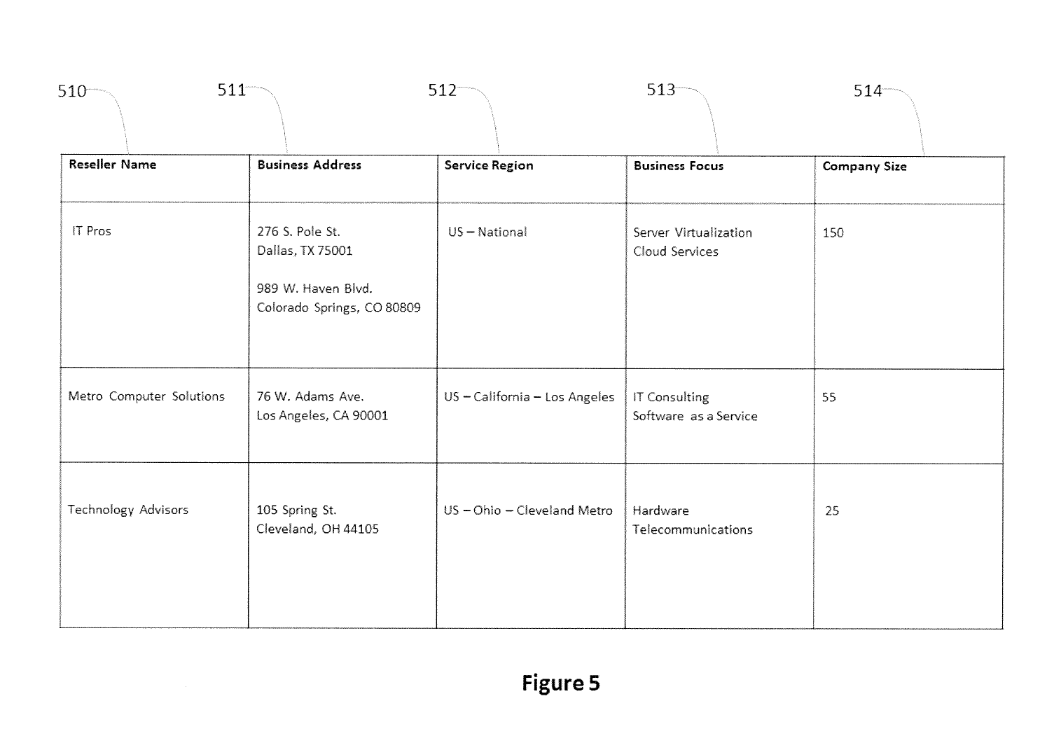

FIG. 5 depicts the reseller account database, which stores reseller profile information such as reseller name, business address, service region, business focus, and company size.

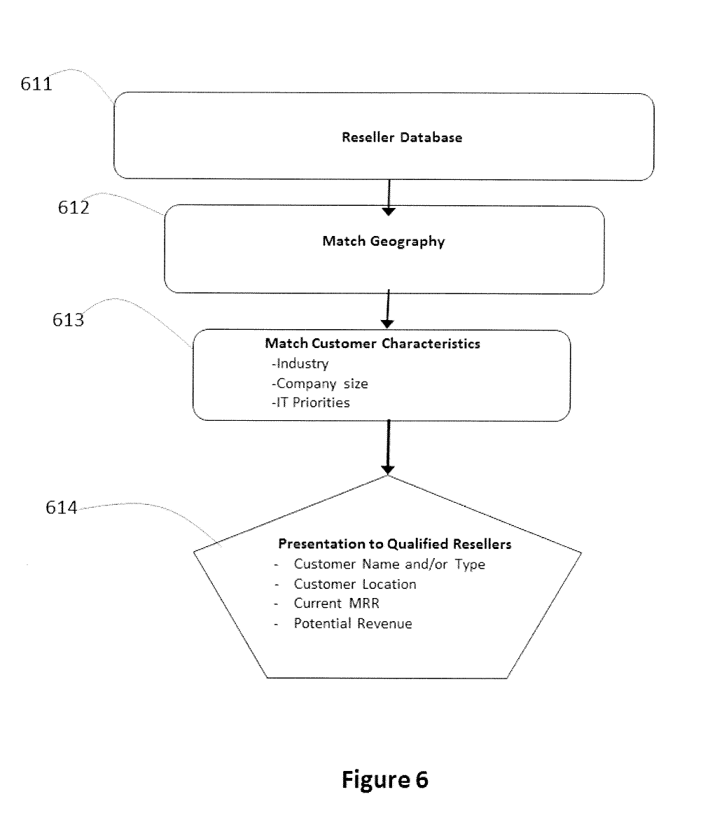

FIG. 6 depicts an example reseller prequalification process.

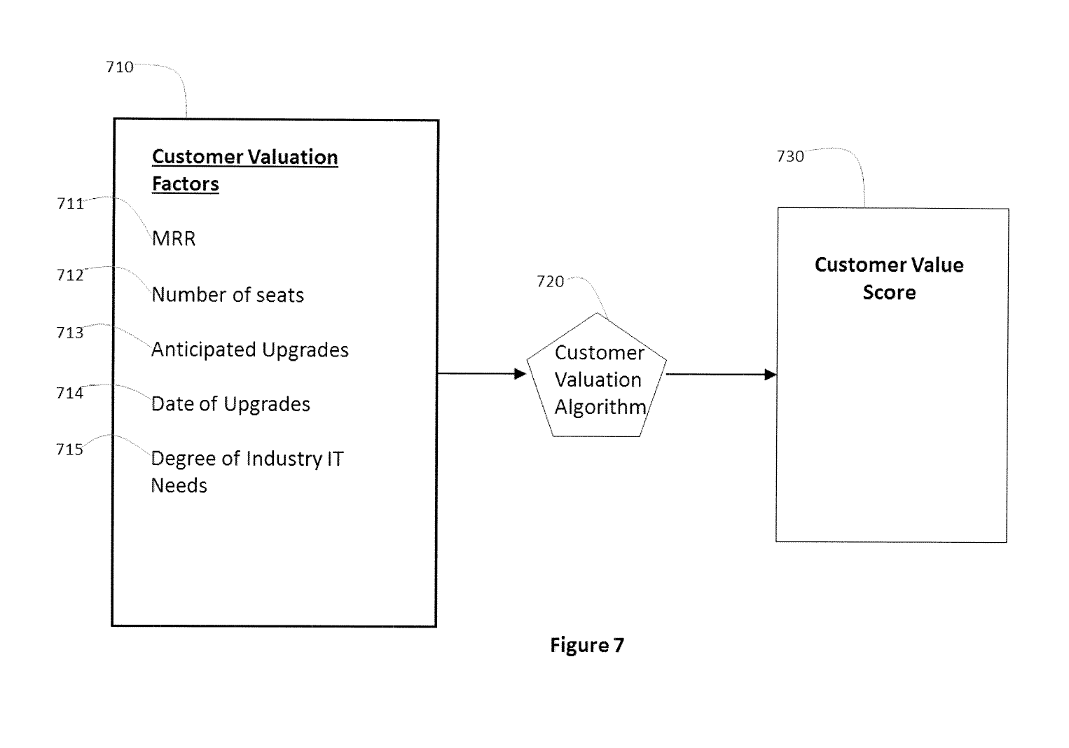

FIG. 7 depicts an example customer valuation process.

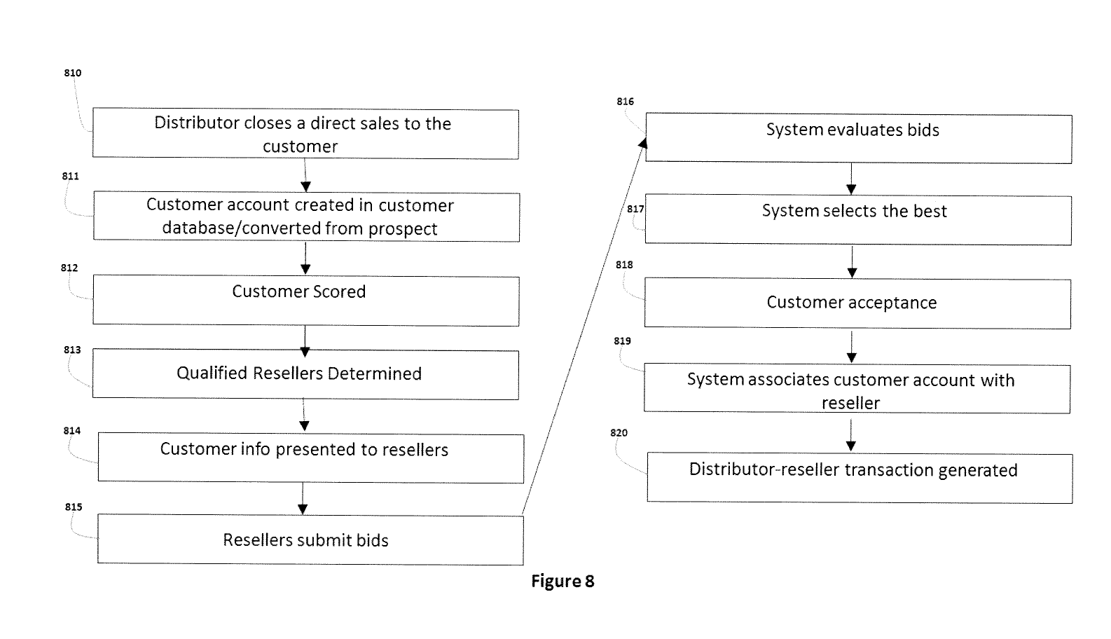

FIG. 8 depicts one embodiment of a bidding process executed by the system.

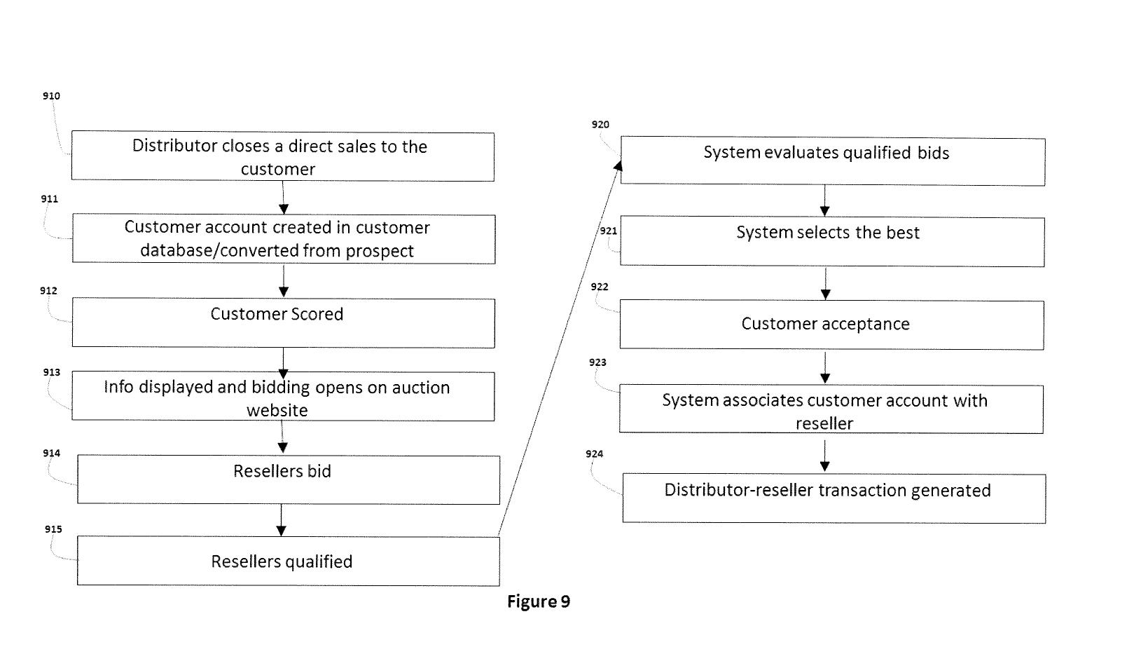

FIG. 9 depicts another embodiment of a bidding process executed by the system.

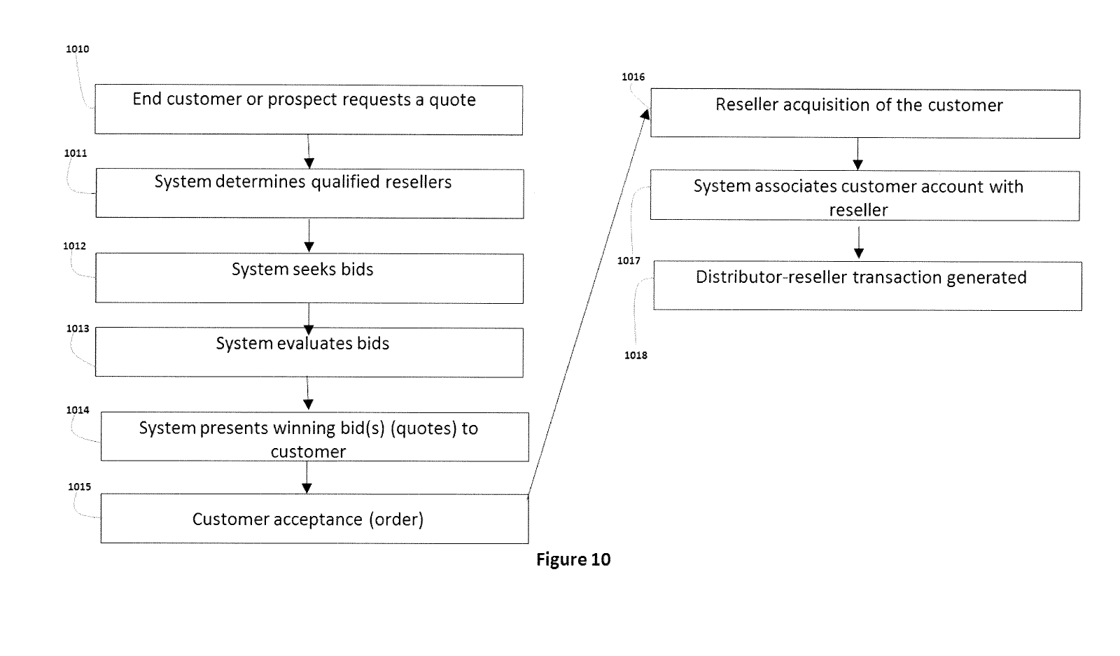

FIG. 10 depicts another embodiment of a bidding process executed by the system.

### DETAILED DESCRIPTION

The following paragraphs describe the invention in detail, referring to the attached drawings by way of example. The preferred embodiment and drawings are examples only and should not be considered limitations on the invention.

Referring to FIG. 1, a supply chain that delivers cloud services from the vendor to end customers (“companies”) is outlined. In some instances (not shown), a reseller purchases cloud services directly from the vendor and sells those services to companies. In other instances, however, a distributor 101 aggregates many cloud services from multiple vendors 110, 111, and 112, for sale to resellers 120, 121, and 122. In some instances, a distributor 101 may sell cloud services to a reseller 122, which in turn sells to other resellers 130, 131, and 132. In this example, reseller 122 is known as an “upstream reseller,” and resellers 130, 131, and 132 are known as “downstream resellers” of reseller 122. These downstream resellers, in turn, sell the services to yet another entity. For example, reseller 130 may then sell the cloud services to companies 140 and 141. In some cases, the upstream reseller 122 is a “master agent,” and downstream resellers 130, 131, 132 are known as “subagents.” This nomenclature often applies where the master agent recruits the subagents for the distributor, the distributor sells to the subagents, and the master agent receives a commission for the subagents' sales to companies or other resellers. In some instances, the supply chain involves only a single reseller, as for example reseller 120 selling to companies 150 and 151.

FIG. 2 depicts aspects of a computing environment in accordance with at least one embodiment of the invention. The bidding system 200 accepts connections from multiple client computer devices of a variety of types, including phone device 210, notebook device 211, tablet device 212, and computer device 213.

The internal structure of the billing system is displayed in FIG. 3. The system runs on computer hardware consisting of servers 310, which run a database set 320 and a process set 330. User interaction with the system occurs through a User Interface 340. The database set 320 consists of Customer Accounts 321, Reseller Accounts 322, Reseller Rules 323, and Subscriptions 324. Processes 330 that operate on these databases include Customer Valuation 331, Bid Analysis 332, and Customer/Reseller Matching 333.

When a distributor engages directly with an end customer, an account for the customer is created in the system. In one embodiment, the customer orders through a self-service web-based interface and enters its own account and profile information into the system. In another embodiment, the distributor engages the end customer through a telemarketing campaign, and the distributor's users enter the customer's account information into the system. FIG. 4 depicts an example of the customer information that may be stored in the customer account database: customer name 410, business address 411, industry 412, number of employees 413, and computer equipment 424.

In addition to information provided by the customer itself, in some embodiments, information may be collected from end customers through marketing automation systems or data collection firms. Such additional information may include information about the technology hardware and software currently employed by the end customer, and the customer's plans for adopting new technologies and migrating to cloud-based services. Distributors generally sell through resellers, as shown in FIG. 1. In one embodiment, the distributor uses a web-based ordering and billing platform to sell its products and services, and this system communicates with the customer account bidding system. Resellers sign an agreement with the distributor and complete profile information as a part of the on-boarding process. In another embodiment, the bidding system is stand-alone, and resellers register and complete profile information for the specific purpose of taking part in auctions. Either way, FIG. 5 shows an example of the kind of information stored in the Reseller Database: Reseller Name 510, Business Address 511, Service Region 512, Business Focus 513, and Company Size 514.

In some embodiments, the system pre-qualifies resellers in the reseller database and presents customer information only to those determined qualified to serve a particular customer. An example qualification process performed by the system is shown in FIG. 6. Beginning with the information in the Reseller Database 611, the system then checks the geography served by each reseller against the location of the customer 612, then checks the remaining reseller profiles against factors such as the customer's industry, size, and IT priorities 613. The system then presents to the qualified resellers enough information to permit the reseller to bid, such as the customer's name or type and location. The system also presents the reseller with information necessary to determine its bid: the current recurring revenue associated with the customer, and the customer's potential revenue or index of the customer's expected value 614.

An example customer valuation process is depicted in FIG. 7. The system uses specific factors 710 such as current monthly recurring revenue (MRR) associated with the customer 711, number of seats (company employees) 712, value or quantity of anticipated IT upgrades 713, anticipated date of those upgrades 714, and the degree to which the customer's industry predicts significant IT needs or spending 715. The system's valuation algorithm 720 uses these factors to score the customer's anticipated value to the reseller 730.

Bidding may be structured in a number of ways. In one embodiment, depicted in FIG. 8, the bidding for a customer is triggered by the distributor closing a direct sale to a customer of a product or service for which the pricing model is a recurring charge 810. A customer account is created in the system, or an account established for a prospect is converted to a customer account 811. The customer is scored 812 according to a process like the one depicted in FIG. 7. The system then defines a list of qualified resellers 813. The customer information, including the score, is then presented to the qualified resellers and bids are solicited 814. Resellers submit bids 815, and the system evaluates the bids 816 and selects the best 817.

The bidding process may be further automated by enabling resellers to store rules in a reseller rules database. This allows a reseller to set preferences so that the system automatically enters a bid for the reseller if a customer becomes available that meets certain criteria: has a certain score, is associated with a particular amount of recurring revenue, etc. The settings may include a mechanism for limiting the number of simultaneous bids, and/or require the reseller's manual approval before finalizing any bid or customer acquisition transaction.

The distributor may configure the system to reject any offer that does not meet a certain threshold. This threshold calculation may include a certain margin percentage, or be based on customer acquisition cost. The system may also be configured so that a distributor administration or other user is presented with bid options and makes the final selection manually, or so that the winning bid selected by the system requires manual approval before finalization.

In the preferred embodiment, some form of customer acceptance is required in order for the customer acquisition to be completed 818. This may take the form of the customer's acceptance of an offer from the reseller that is associated with the bid. For example, the bidding reseller may offer a promotion for a new product (such as one that the reseller acquires from the distributor and resells but that the customer is not currently buying), or an offer related to one of the customer's existing subscriptions with the distributor (such as an offer of a free month or one-time or recurring discount).

Once there is a winning bid and any required final approval by the reseller or customer, the system associates the customer account with the reseller 819 and generates the appropriate transaction between the distributor and the reseller 820. This may take the form of a one-time charge to the reseller through an invoice or automatic charge to the reseller's credit card or bank account. It may also take the form of a recurring transaction between the distributor and reseller. For example, a reseller's bid may take the form of a certain monthly buy rate from the distributor, and/or purchase price to the customer. If the bid is finalized, the new rate plan takes effect. A bid consisting of a monthly commission arrangement would likewise generate a recurring transaction.

Customer acquisition bidding may take the form of an ongoing, online auction. As new customers are added, limited customer profile information is posted on the distributor's members-only website for resellers to bid. As shown in FIG. 9, the distributor closes a direct sale to an end customer 910. A customer account is created in the system, or an account for a prospect is converted to a customer account 911, and the system gives the customer a score that indicates its revenue potential 912. The relevant customer information is displayed on the online interface 913. This information includes a deadline for submitting bids. Resellers then bid on the customers 914. The system qualifies the resellers to ensure they are a good match for the customer 915, either before accepting the bid, or after the close of the bidding as the first step of the bid evaluation process. The system evaluates the qualified bids 920. It either selects the best bid 921 or presents a ranked list of qualified bids to the distributor. Customer acceptance is generally required to close the deal 922. This may take the form of the customer's acceptance of a price quote through the online system (converting the quote to an order), or the customer's use of a promotion code or coupon. Once the offer is accepted by the distributor and the customer, if applicable, the system associates the customer account with the reseller 923, and generates the appropriate distributor-reseller transaction.

In another implementation, instead of being held on an ongoing basis, the auction described above could be held on a periodic basis, such as monthly, or when a specific number of new end customers are available for acquisition.

Another possible triggering event is a request from an existing or prospective customer of the distributor for a quote for a particular product or service. As shown in FIG. 10, when a customer or prospect requests a quote 1010, the system determines which resellers are qualified 1011, then seeks bids from those resellers 1012. Bids may be solicited through a members-only website, an email message, or a notification through the online ordering/bidding system. In the example shown, bids consist of the reseller's offer to the end customer and the reseller's offer to the distributor. The reseller's offer to the customer may include preferential pricing, one-time or recurring discounts, or other promotions. The reseller's offer to the distributor may be an offer of one-time payment, or a given percentage of the current and/or future recurring revenue associated with the customer. This process may be automated by pre-gathering certain information from resellers and storing it in a reseller rules database 322. In this manner, the reseller may pre-load the necessary preferences into the system so that quotes can be generated nearly instantaneously. The system evaluates the bids 1013, and either selects the best bid or a defined number of top bids and presents the winning quote or quotes to the customer accordingly 1014. The distributor may fully automate the selection of a bid or bids, or require manual distributor approval before quotes are presented to the customer. If the customer selects a quote by placing an order 1015, the reseller has acquired the customer 1016. The system then associates the customer account with the reseller 1017, and generates the appropriate distributor-reseller transaction 1018.

Alternatively, the described bidding process may be triggered by the customer's request for a particular reseller service complementary to the distributor's products but not offered by the distributor. For example, cloud technologies may require installation or configuration. This request may be made by way of interaction with the distributor's online marketplace, a ‘find a partner’ option on the distributor's website, or telephone interaction with the distributor's sales representatives.

In yet another embodiment, the described methods are used simply as an inducement to resellers to do business with the distributor. “Doing business” means buying cloud services from the distributor and reselling them to end customers. In this instance, the “auction” consists of matching a prospective, new or inactive reseller with a recurring revenue-generating end customer. In this embodiment, the system: 1) defines the list of resellers eligible for such an incentive program, 2) determines which are qualified, based on geography and business characteristics, to serve the end customer, 3) then selects or ranks the qualified resellers. The distributor may determine how to best use this information to induce resellers to join its program or increase sales activity.

While there have been described above the principles of the present invention in conjunction with specific systems and methods of operation, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicant hereby reserves the right to formulate new claims to such features and/or combinations of such features during the prosecution of the present application or of any further application derived therefrom.

The invention claimed is:

1. A method for an IT distributor to match end customers with IT consultants (resellers) through an online bidding system, comprising:
a. providing a computing cloud including
i. at least one processing unit;
ii. a networking layer, comprising a communication interface and a security infrastructure, configured to receive data from multiple client systems and environments;
iii. a database layer for storing data, including customer and reseller account information, reseller rules, and subscriptions;
iv. a processing layer configured to perform multiple processing functions, including customer valuation, bid analysis, and customer and reseller matching;
b. creating customer accounts and profiles that include data such as geographic location, business size and type, and purchasing history;
c. creating reseller accounts and profiles that include data such as geographic locations served and types of customers served and desired;
d. soliciting bids from resellers;
e. accepting bids from resellers;
f. ranking bids or selecting a winning bid; and
g. generating a transaction between the distributor and the reseller that reflects the winning bid.

2. The method of claim 1, where customer and/or prospective customer profiles include information acquired through marketing automation systems or through the purchase of data collected by marketing firms.

3. The method of claim 1, further comprising a process for scoring customers to indicate their value and potential to generate additional revenue for the reseller.

4. The method of claim 1, further comprising a process for pre-qualifying resellers, and opening bidding only to qualified resellers.

5. The method of claim 1, where the bidding takes place through an ongoing online auction.

6. The method of claim 1, where bidding is held on a periodic basis, such as monthly.

7. The method of claim 1, where bidding is held when some other target has been reached, such as when a specific number of new customers have been added by the distributor.

8. The method of claim 1, where solicitation of bids is triggered by a customer's request for a quote for a particular product or service.

9. The method of claim 1, further comprising automatic bidding on behalf of resellers using one or more predefined rules.

10. The method of claim 9, further including a requirement that the winning reseller manually approve before customer acquisition is finalized.

11. The method of claim 1, comprising ranking reseller bids and presenting ranked bids to the distributor for manual selection.

12. The method of claim 1, comprising automatically selecting a winning bid based on criteria stored in the system.

13. The method of claim 1, where the system is further configured to automatically reject any bid that does not meet a certain threshold established by the distributor.

14. The method of claim 1, further comprising a requirement of customer acceptance.

15. The method of claim 1, where the reseller's bid includes an offer to the customer.

16. The method of claim 15, where the customer's acceptance of the reseller's offer is required before the bid is finalized.

17. The method of claim 1, where the transaction generated as a result of the winning bid also includes a transaction between the reseller and the end customer.

18. The method of claim 1, where the transaction generated as a result of the winning bid is a one-time charge from the distributor to the reseller, or one-time payment to the distributor by the reseller.

19. The method of claim 1, where the transaction generated as a result of the winning bid is a recurring transaction.

20. A system comprising a computing cloud including at least one processing unit for an IT distributor configured to match resellers with end customers already associated with recurring revenue in order to induce resellers to do business with the distributor.

21. A method comprising providing a computing cloud including at least one processing unit for an IT distributor matching resellers with end customers already associated with recurring revenue in order to induce resellers to do business with the distributor.
